(19) United States
(12) Patent Application Publication
(10) Pub. No.: US 2016/0191575 A1
(43) Pub. Date: Jun. 30, 2016

(54) Bridge Device for Large Meetings

(71) Applicant: Microsoft Technology Licensing, LLC, Redmond, WA (US)

(72) Inventors: Shreyans Rai Jain, Redmond, WA (US); Anton W. Krantz, Kirkland, WA (US)

(21) Appl. No.: 14/586,621

(22) Filed: Dec. 30, 2014

(51) Int. Cl. H04L 29/06; H04M 3/56; H04M 7/00

(52) U.S. Cl. CPC H04L 65/403; H04M 7/0012; H04M 3/56

(57) ABSTRACT

Various embodiments provide a bridge device that can enable a conferencing communication platform, such as audio/visual conferencing software, to discover that it is in a large meeting context and, automatically enter a so-called “large meeting mode.” In the large meeting mode, the conferencing communication platform can automatically apply policies associated with establishing the meeting and automatically select meeting room equipment for use during the meeting. In addition, the conferencing communication platform can provide a user interface experience to enable a meeting organizer to quickly select and/or modify various meeting parameters.

### BACKGROUND

One problem that is encountered today in the context of conducting large meetings, e.g., meetings with 50, 100 or more people, is that there tends to be a disconnect between local attendees and remote attendees. Most often, remote attendees are not able to hear or see the meeting content very clearly. Remote attendees typically also encounter difficulty when attempting to participate or speak in the meeting because they are either muted or the meeting room equipment does not support relaying the audio from remote participants to the room's speakers. Furthermore, many commercially available conferencing software packages do not integrate with equipment that might be present in a large meeting room or multipurpose room, e.g., room projectors, room speakers, and the like.

Further, to support large meetings, such as those in corporate settings and other settings as well, typically a number of technical support people are needed to organize meeting room equipment and make the relevant connections between computing devices equipment, mixers, speakers, and the like prior to the meeting taking place. This process is often time-consuming.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments provide a bridge device that can enable a conferencing communication platform, such as audio/visual conferencing software, to discover that it is in a large meeting context and, automatically enter a so-called “large meeting mode.” In the large meeting mode, the conferencing communication platform can automatically apply policies associated with establishing the meeting and automatically select meeting room equipment for use during the meeting. In addition, the conferencing communication platform can provide a user interface experience to enable a meeting organizer to quickly select and/or modify various meeting parameters.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 illustrates a bridge device in accordance with one or more embodiments.

FIG. 3 illustrates an example computing environment in accordance with one or more embodiments.

FIG. 4 illustrates a user interface in accordance with one or more embodiments.

FIG. 5 illustrates a user interface in accordance with one or more embodiments.

FIG. 6 illustrates a user interface in accordance with one or more embodiments.

FIG. 7 illustrates a user interface in accordance with one or more embodiments.

FIG. 8 is a flow diagram that describes steps in a method in accordance with one or more embodiments.

FIG. 9 is a flow diagram that describes steps in a method in accordance with one or more embodiments.

FIG. 10 illustrates an example computing device that can be utilized to implement various embodiments described herein.

### DETAILED DESCRIPTION

Overview

Various embodiments provide a bridge device that can enable a conferencing communication platform, such as audio/visual conferencing software, to discover that it is in a large meeting context and, automatically enter a so-called “large meeting mode.” A “large meeting context” or a “large meeting” can be defined or characterized in different ways. For example, a large meeting context or large meeting can be characterized by the use of external audio/visual equipment such as meeting room speakers, projectors, external microphones and the like. Alternately or additionally, a large meeting context or large meeting can be characterized by the number of participants, e.g., more than 5 or 10.

In the large meeting mode, the conferencing communication platform can automatically apply policies associated with establishing the meeting and automatically select meeting room equipment for use during the meeting. In addition, the conferencing communication platform can provide a user interface experience to enable a meeting organizer to quickly select and/or modify various meeting parameters.

In at least some embodiments, the bridge device is a device that is external to the computing device that is used to conduct the meeting, e.g., the meeting organizer's laptop, tablet, or other computing device. In at least some other embodiments, the functionality associated with the bridge device is internal to the computing device that is used to conduct the meeting. In the examples described below, the bridge device is described in the context of being external to the meeting organizer's computing device. It is to be appreciated and understood, however, that such is simply an implementation example and is not intended to limit application of the claimed subject matter to external devices only.

In operation, as described in more detail below, the bridge device is used to connect multiple devices such as a meeting room microphone, meeting room speakers, camera, projector, and the like to a computing device executing a conferencing communication platform. The conferencing communication platform can reside in any suitable form. In at least some embodiments, the conferencing communication platform constitutes enterprise software having various features to enable remote and local meeting participants to conduct an online meeting. These features can include, by way of example and not limitation, instant messaging, Voice Over IP, video conferencing, and the like. An example of a commercially available conferencing communication platform is Microsoft's Lync.

The bridge device can enable a single user to quickly and efficiently organize, start, and conduct a meeting with both local and remote participants. This can eliminate dependencies on Information Technology (IT) support personnel and other specialists that are typically used to organize large meetings. Furthermore, the bridge device can utilize pre-existing infrastructure in the meeting room thereby eliminating the need for specialized equipment, interfaces, and the like. Further, the bridge device can enhance the meeting experience of remote participants by enabling them to hear, see, and be seen just like local participants. The meeting can be broadcast through the meeting organizer's computing device, using the conferencing communication platform, to other remote users' computing devices that are executing instances of the conferencing communication platform. Alternately, remote participants can join a particular meeting by joining a webcast on a website associated with the meeting.

In the following discussion, an example environment is first described that is operable to employ the techniques described herein. The techniques may be employed in the example environment, as well as in other environments.

Example Environment

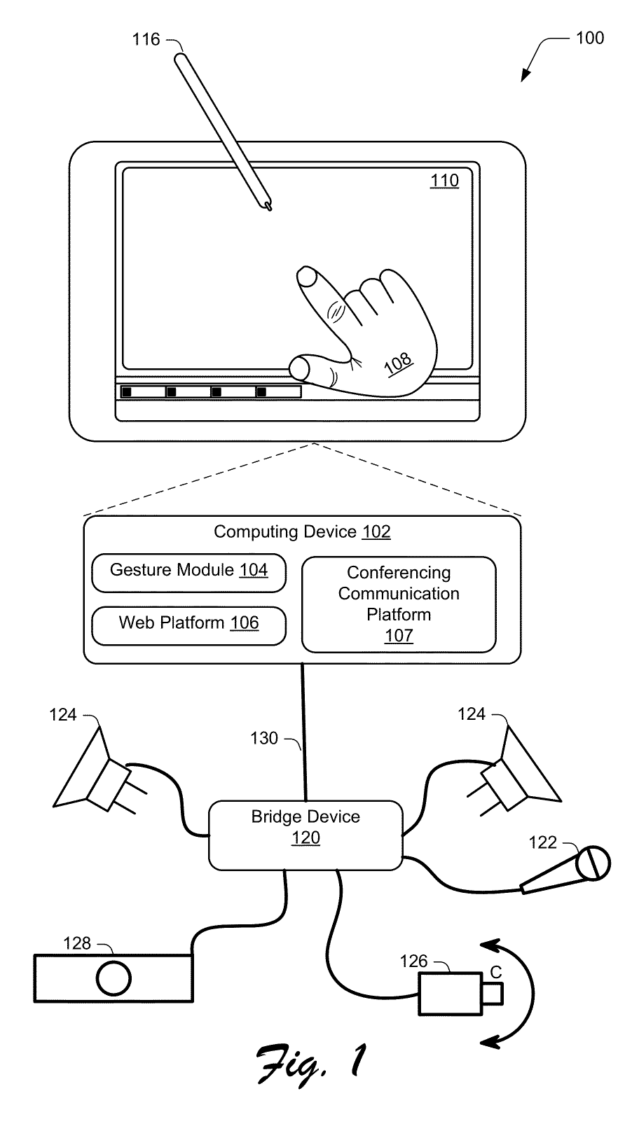

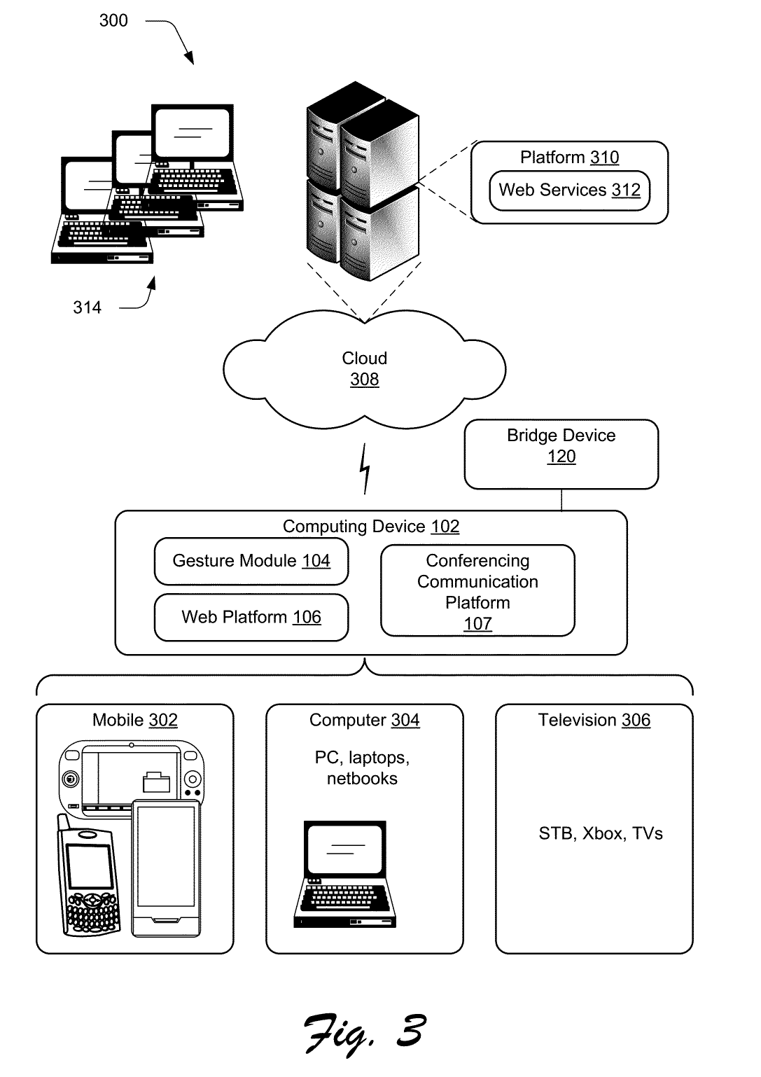

FIG. 1 is an illustration of an environment 100 in an example implementation that is operable to employ the techniques as described herein. The illustrated environment 100 includes an example of a computing device 102 that may be configured in a variety of ways. In this example, computing device 102 represents a meeting organizer's computing device that is utilized to plan and conduct a large meeting. The computing device 102 may be configured as a traditional computer (e.g., a desktop personal computer, laptop computer, and so on), a mobile station, a wireless phone, a netbook, a handheld device, and so forth as further described in relation to FIG. 3. Thus, the computing device 102 may range from full resource devices with substantial memory and processor resources (e.g., personal computers) to a low-resource device with limited memory and/or processing resources. The computing device 102 also includes software that causes the computing device 102 to perform one or more operations as described below.

Computing device 102 can include, by way of example and not limitation, a number of different components including a gesture module 104, a web platform 106, and a conferencing communication platform 107.

The gesture module 104 is operational to provide gesture functionality. The gesture module 104 can be implemented in connection with any suitable type of hardware, software, firmware or combination thereof. In at least some embodiments, the gesture module 104 is implemented in software that resides on some type of computer-readable storage medium examples of which are provided below.

Gesture module 104 is representative of functionality that recognizes gestures that can be performed by one or more fingers, and causes operations to be performed that correspond to the gestures. The gestures may be recognized by module 104 in a variety of different ways. For example, the gesture module 104 may be configured to recognize a touch input, such as a finger of a user's hand 108 as proximal to display device 110 of the computing device 102 using touchscreen functionality.

It is to be appreciated and understood that a variety of different types of gestures may be recognized by the gesture module 104 including, by way of example and not limitation, gestures that are recognized from a single type of input (e.g., touch gestures such as the previously described drag-and-drop gesture) as well as gestures involving multiple types of inputs. For example, module 104 can be utilized to recognize single-finger gestures and bezel gestures, multiple-finger/same-hand gestures and bezel gestures, and/or multiple-finger/different-hand gestures and bezel gestures.

For example, the computing device 102 may be configured to detect and differentiate between a touch input (e.g., provided by one or more fingers of the user's hand 108) and a stylus input (e.g., provided by a stylus 116). The differentiation may be performed in a variety of ways, such as by detecting an amount of the display device 110 that is contacted by the finger of the user's hand 108 versus an amount of the display device 110 that is contacted by the stylus 116.

Thus, the gesture module 104 may support a variety of different gesture techniques through recognition and leverage of a division between stylus and touch inputs, as well as different types of touch inputs.

The web platform 106 is a platform that works in connection with content of the web, e.g. public content. A web platform 106 can include and make use of many different types of technologies such as, by way of example and not limitation, URLs, HTTP, REST, HTML, CSS, JavaScript, DOM, and the like. The web platform 106 can also work with a variety of data formats such as XML, JSON, and the like. Web platform 106 can include various web browsers, web applications (i.e. “web apps”), and the like. When executed, the web platform 106 allows the computing device to retrieve web content such as electronic documents in the form of webpages (or other forms of electronic documents, such as a document file, XML file, PDF file, XLS file, etc.) from a Web server and display them on the display device 110. It should be noted that computing device 102 could be any computing device that is capable of displaying Web pages/documents and connect to the Internet.

Conferencing communication platform 107 is representative of software that enables meetings to be conducted using various features which can include, by way of example and not limitation, instant messaging, Voice Over IP, video conferencing, and the like. The conferencing communication platform operates as described above and below.

In addition, environment 100 includes a bridge device 120. In the illustrated and described embodiment, the bridge device 120 provides a relatively small, portable, single device through which all relevant connections between meeting room equipment and the conferencing communication platform 107 can be made. In at least some embodiments, the bridge device 120 uses a single connection between a computing device and itself to enable the computing device to run a meeting as described below in more detail. This significantly reduces the complexity associated with enabling a meeting organizer to plan and execute a large meeting with both local and remote participants. In addition, in at least some embodiments, the bridge device 120 is configured to automatically establish connections between the meeting room equipment and the conferencing communication platform 107 which, in turn, can eliminate the need for multiple technical support individuals. Further, by having a single device through which all relevant connections are made, in some instances automatically, a single meeting organizer can simply plug into the bridge device 120 and start the meeting in a much faster, streamlined and efficient manner than in the past.

In the present example, the bridge device 120 is used to connect multiple devices such as a meeting room microphone 122, meeting room speakers 124, camera 128, projector 126, and the like to computing device 102 executing conferencing communication platform 107. In the illustrated and described example, computing device 102 is connected to bridge device 120 by way of a data transfer interface 130. Any suitable type of data transfer interface can be utilized such as a high-speed media interface including, by way of example and not limitation, an audio/visual high-speed media interface. One specific example of such an interface is a USB interface. Alternately or additionally, the data transfer interface can be a wireless high-speed interface.

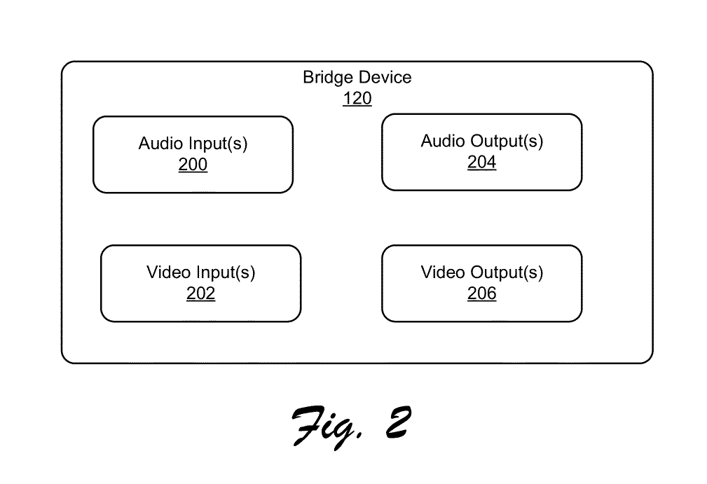

FIG. 2 illustrates other example connection types between the bridge device 120 and the various multiple devices including, by way of example and not limitation, audio inputs 200, video inputs 202, audio outputs 204, and video outputs 206.

With respect to audio inputs 200, the bridge device 120 can include an unbalanced line input from the room microphone 122. Alternately or additionally, the bridge device 120 can include a 3.5 mm input from the room microphone 122. Other audio connection types can be utilized as well.

With respect to video inputs 202, the bridge device 120 can include a VGA input from camera 126. Alternately or additionally, the bridge device 120 can include an HDMI input from camera 126. Alternately or additionally, the bridge device 120 can include a USB input from a USB high resolution PTZ camera 126. Other video connection types can be utilized as well.

With respect to audio outputs 204, the bridge device 120 can include, as noted above, a USB output serving to enable audio data to be sent to conferencing communication platform 107. The bridge device 120 can also include an unbalanced line output to the room speakers 124. Alternately or additionally, the bridge device 120 can include a 3.5 mm output to the room speakers 124. Other audio connection types can be utilized as well.

With respect to video outputs 206, the bridge device 120 can include an HDMI output to the projector 128. Alternately or additionally, the bridge device 120 can include a VGA output to the projector. The bridge device 120 can also include, as noted above, a USB video output serving to enable video data to be sent to conferencing communication platform 107. Other video connection types can be utilized as well.

FIG. 3 illustrates an example system 300 showing the components of FIGS. 1 and 2, e.g., conferencing communication platform 107, as being implemented in an environment where multiple devices are interconnected through a central computing device. The conferencing communication platform 107 can enable meetings to be conducted using various features which can include, by way of example and not limitation, instant messaging, Voice Over IP, video conferencing, and the like.

The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 302, computer 304, and television 306 uses. Each of these configurations has a generally corresponding screen size and thus the computing device 102 may be configured as one of these device classes in this example system 300. For instance, the computing device 102 may assume the mobile 302 class of device which includes mobile telephones, music players, game devices, and so on. The computing device 102 may also assume a computer 304 class of device that includes personal computers, laptop computers, netbooks, tablets, and so on. The television 306 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

As described above, computing device 102 includes a conferencing communication platform 107 that operates as described above and below by way of bridge device 120.

Cloud 308 is illustrated as including a platform 310 for web services 312. The platform 310 abstracts underlying functionality of hardware (e.g., servers) and software resources of the cloud 308 and thus may act as a “cloud operating system.” For example, the platform 310 may abstract resources to connect the computing device 102 with other computing devices. The platform 310 may also serve to abstract scaling of resources to provide a corresponding level of scale to encountered demand for the web services 312 that are implemented via the platform 310. A variety of other examples are also contemplated, such as load balancing of servers in a server farm, protection against malicious parties (e.g., spam, viruses, and other malware), and so on.

Thus, the cloud 308 is included as a part of the strategy that pertains to software and hardware resources that are made available to the computing device 102 via the Internet or other networks. For example, aspects of the conferencing communication platform 107 may be implemented in part on the computing device 102 as well as in a distributed fashion via platform 310 that supports web services 312.

In addition, system 300 includes one or more remote computing devices 314 associated with remote participants to can participate in a meeting organized and conducted through computing device 102 by way of bridge device 120. Each of the remote computing devices 314 executes a conferencing communication client that enables communication with conferencing communication platform 107.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

For example, the computing device may also include an entity (e.g., software) that causes hardware or virtual machines of the computing device to perform operations, e.g., processors, functional blocks, and so on. For example, the computing device may include a computer-readable medium that may be configured to maintain instructions that cause the computing device, and more particularly the operating system and associated hardware of the computing device to perform operations. Thus, the instructions function to configure the operating system and associated hardware to perform the operations and in this way result in transformation of the operating system and associated hardware to perform functions. The instructions may be provided by the computer-readable medium to the computing device through a variety of different configurations.

One such configuration of a computer-readable medium is a signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

In the discussion that follows, a section entitled “Automatic Large Meeting Mode” describes various operational aspects associated with a so-called large meeting mode. Following this, a section entitled “Example Methods” describes example methods in accordance with one or more embodiments. Next, a section entitled “Implementation Details and USB Embodiments” describes aspects of an implementation that utilizes USB principles. Last, a section entitled “Example Device” describes aspects of an example device that can be utilized to implement one or more embodiments.

Automatic Large Meeting Mode

In one or more embodiments, when the computing device 102 or conferencing communication platform 107 detects that the computing device is connected to the bridge device 120, the conferencing communication platform 107 can automatically configure itself into a so-called large meeting mode. In the large meeting mode, the conferencing communication platform 107 can automatically apply certain policies with respect to the meeting settings and configurations. This can include, by way of example and not limitation, establishing meeting equipment connections, setting permissions associated with the meeting, presenting a user interface to enable the meeting organizer to modify meeting settings and configurations, and the like.

As an example, consider the following. When the meeting organizer connects his or her computing device 102 to bridge device 120 (assuming that the bridge device is connected to the various meeting room equipment or devices), the conferencing communication platform 107 can discover which meeting room devices are connected to the bridge device 120. So, for example, using the FIG. 1 example, when computing device 102 is connected to bridge device 120, the conferencing communication platform 107 can ascertain that the bridge device is connected to external microphone 122, external speakers 124, external camera 126 and external projector 128. Because these devices are the types of devices that are typically used in large meeting scenarios, the conferencing communication platform 107 can ascertain that it is in a large meeting scenario. By virtue of ascertaining that it is in a large meeting scenario, the conferencing communication platform 107 can automatically select the devices as the devices to use for the meeting. So, in this instance, the conferencing communication platform 107 can automatically configure the physical device for the meeting that is to be conducted.

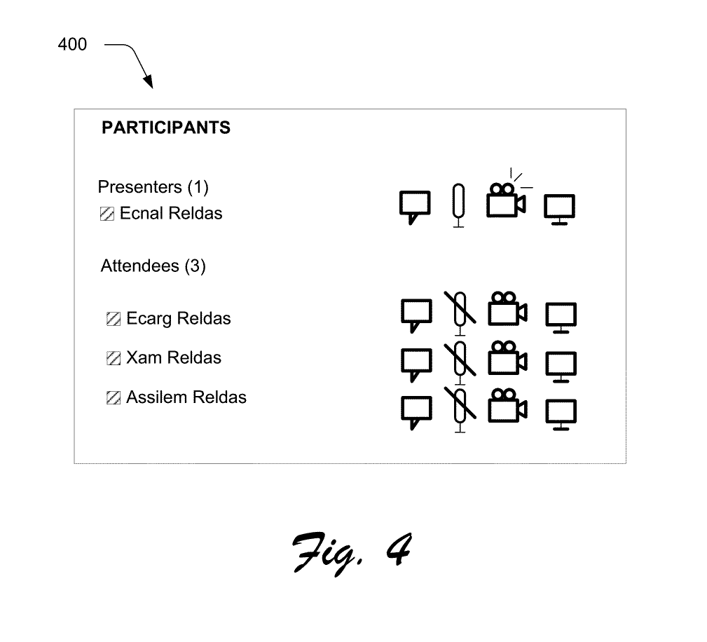

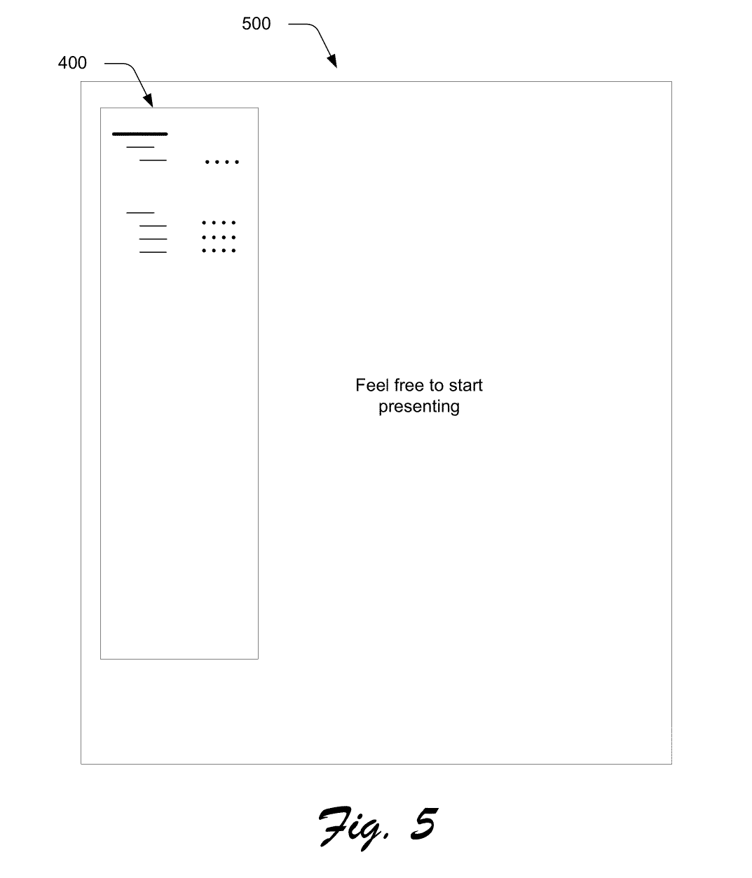

In addition to automatically selecting the various meeting room devices as the devices to use for the meeting, one or more other actions can be automatically performed by the conferencing communication platform 107. As an example, consider FIG. 4 which illustrates an example user interface 400 that can be presented by conferencing communication platform 107 when the platform detects that its associated computing device is connected to the bridge device. In this particular example, the conferencing communication platform 107, in addition to automatically selecting the meeting room devices as the default devices, can set the user who is signed in to the conferencing communication platform as the “presenter” in the meeting. In this particular example, computing device 102 belongs to Ecnal Reldas who is, in turn, signed into the conferencing communication platform. As such, Ecnal Reldas is set to be the meeting presenter. Alternately or additionally, the conferencing communication platform can designate all other participants (yet to join or already joined), e.g., both local and remote participants, as “attendees”. In this particular example, there are three other attendees. This limits the privileges of these other attendees to present and speak to appropriate participants. Alternately or additionally, the conferencing communication platform can automatically mute all attendees. Alternately or additionally, the conferencing communication platform can lock the video spotlight on the user who is signed into the conferencing communication platform. In this particular instance, the video spotlight is locked on Ecnal Reldas. Further, in at least some embodiments, the conferencing communication platform can convert an associated conversation window to full screen, such as the one shown in FIG. 5.

There, a full screen is shown at 500 and includes a diagrammatic representation of user interface 400 of FIG. 4, as well as a content sharing area just to the right of the user interface 400. The above-described settings can be considered as the default settings that are automatically set by the conferencing communication platform when the computing device detects that it has been plugged into the bridge device.

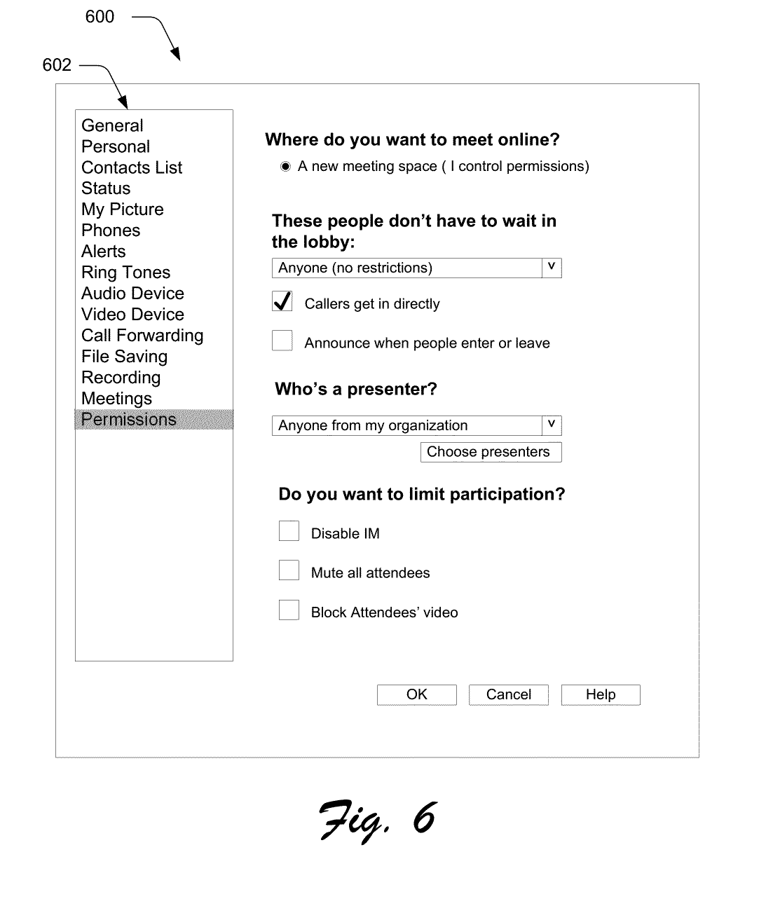

In at least some embodiments, the conferencing communication platform includes a mechanism in the form of a user interface that enables the user or meeting organizer to control meeting privileges. As an example, consider FIG. 6.

There, a user interface in accordance with one or more embodiments is shown generally at 600. Meeting privileges and permissions can be changed or overridden by the meeting organizer through the use of a “Permissions” tab which is shown in a collection of tabs shown generally at 602. Using this tab, the user can select where to meet online. In this particular example, the user can select between a new meeting space and a dedicated meeting space. Alternately or additionally, the user can select who gets into the meeting directly and who has to wait. In this particular example, the user has indicated that callers get in directly. Other selectable options for who can get into the meeting directly include, by way of example and not limitation, only the meeting organizer, people invited to the meeting, and anyone from the organization. Alternately or additionally, the user interface can enable user to select who is a presenter. In this particular example, anyone from the user's organization can be a presenter. Other choices include, by way of example and not limitation, any one and only the meeting organizer. Further, the user interface can allow the user to limit participation through a series of check boxes that set different meeting settings. These settings can be set, by way of user interface 600, when the meeting is being organized or when meeting requests are being sent out.

When pre-organized in this manner, the settings will be automatically enabled when the computing device is connected to the bridge device, much like the way the default settings are automatically enabled when the computing device is connected to the bridge device. In this manner, meetings can be much more efficiently organized and conducted. The user interfaces provided by the conferencing communication platform provide a single location from which the user can organize a meeting on many different levels including permissions, device settings, and the like. This is particularly useful in the context of very large meetings which, in the past, could conceivably require a large number of IT specialists to accomplish tasks that a single user can now accomplish.

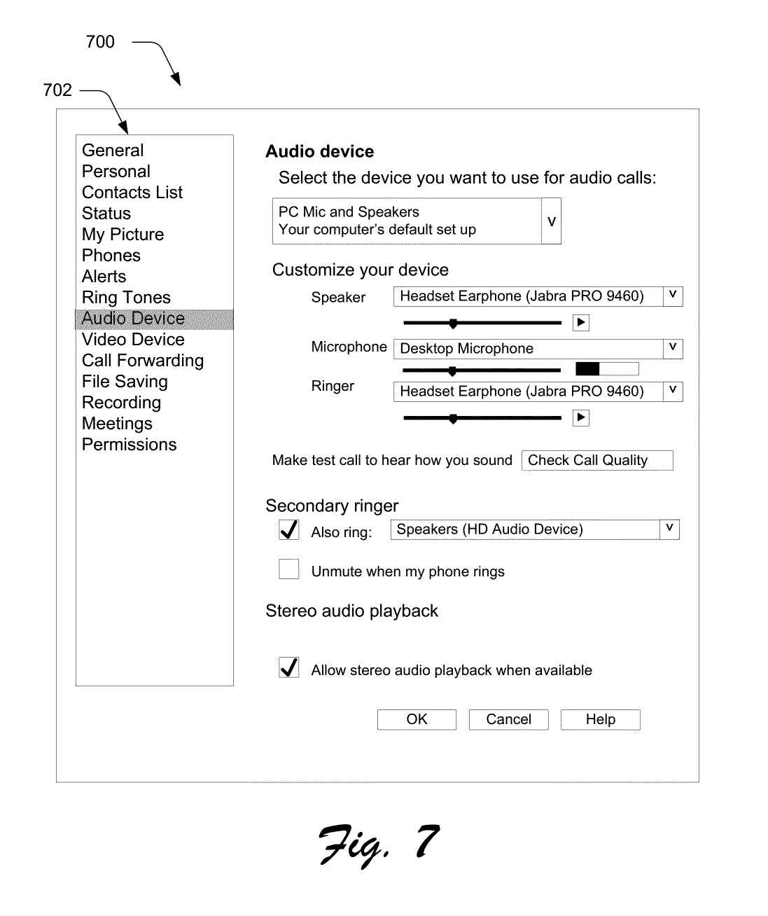

In one or more embodiments, when the computing device running the conferencing communication platform is connected to the bridge device, the bridge device is enlisted in the Audio Device tab and Video Device tab as a USB device for large meeting scenarios. As an example, consider FIG. 7 which illustrates a user interface in accordance with one embodiment generally at 700. In this example, the user interface is accessible by way of the Audio Device tab which appears in the collection of tabs generally at 702. The user interface 700 provides the user, in this case the meeting organizer, with an opportunity to customize their particular device with respect to the large meeting that they are to conduct. In this instance, if the bridge device has multiple speaker outlets, the user can customize which speakers to use through a drop-down menu. In the illustration, this appears under the “Customize your device” region. Similarly, if the device has multiple microphone outlets, the user can again customize which microphone to use through a drop-down menu.

Having considered example user interface is in accordance with one or more embodiments, consider now a discussion of example methods in accordance with one or more embodiments.

Example Methods

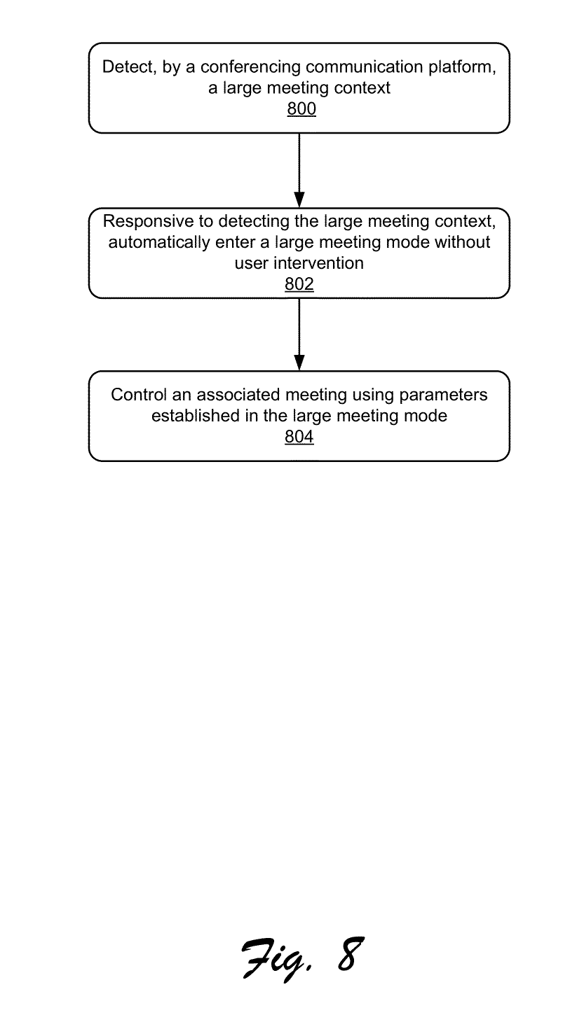

FIG. 8 is a flow diagram that describes steps in a method in accordance with one or more embodiments. The method can be implemented in connection with any suitable hardware, software, firmware, or combination thereof. In at least some embodiments, the method is implemented by a suitably-configured conferencing communication platform in reliance on bridge functionality which may or may not be manifest in the form of a bridge device that is external to a computing device on which the conferencing communication platform executes.

Step 800 detects, by a conferencing communication platform, a large meeting context. This step can be performed in any suitable way. For example, this step can be performed by the conferencing communication platform detecting that the computing device upon which it is executing has been physically connected to a bridge device. The bridge device, as described above, enables the conferencing communication platform to utilize meeting room or conference room equipment or devices to conduct the large meeting. Alternately or additionally, this step can be performed by the conferencing communication platform detecting the presence of meeting equipment that is typically used for a large meeting. Such meeting equipment can include, by way of example and not limitation, external speakers, external microphones, external projectors, and the like. In this manner, the computing device on which the conferencing communication platform is executing can contain internal bridge-type functionality which, by virtue of detecting the external equipment, can automatically enter the large meeting mode. In this example, an external bridge device is not utilized.

Responsive to detecting the large meeting context, in step 802 the conferencing communication platform automatically enters a large meeting mode without user intervention. In this particular example the large meeting mode can include one or more of automatically applying policies associated with establishing the meeting and/or automatically selecting meeting room equipment for use during the meeting. With respect to applying policies, such can include, by way of example and not limitation, turning on or turning off various functions, setting permissions for participants, designating the presenter or presenters, and the like, examples of which are provided above. Examples of automatically selecting meeting room equipment are provided above. The large meeting mode can also include presenting various user interfaces to enable the user or meeting organizer to select or modify various meeting parameters such as, by way of example and not limitation, which meeting equipment is to be used, permissions associated with meeting attendees, and the like.

Step 804 controls an associated meeting using parameters established in the large meeting mode. This step can be accomplished in any suitable way. For example, this step can be performed by using meeting room equipment that was automatically selected for use when the large meeting mode was entered. Alternately or additionally, this step can be performed by presenting various user interfaces, as part of the conferencing communication platform, to enable the meeting organizer to modify meeting parameters, properties, and characteristics from a single point of interaction. This can greatly reduce or eliminate the need for multiple IT specialists to conduct a large meeting.

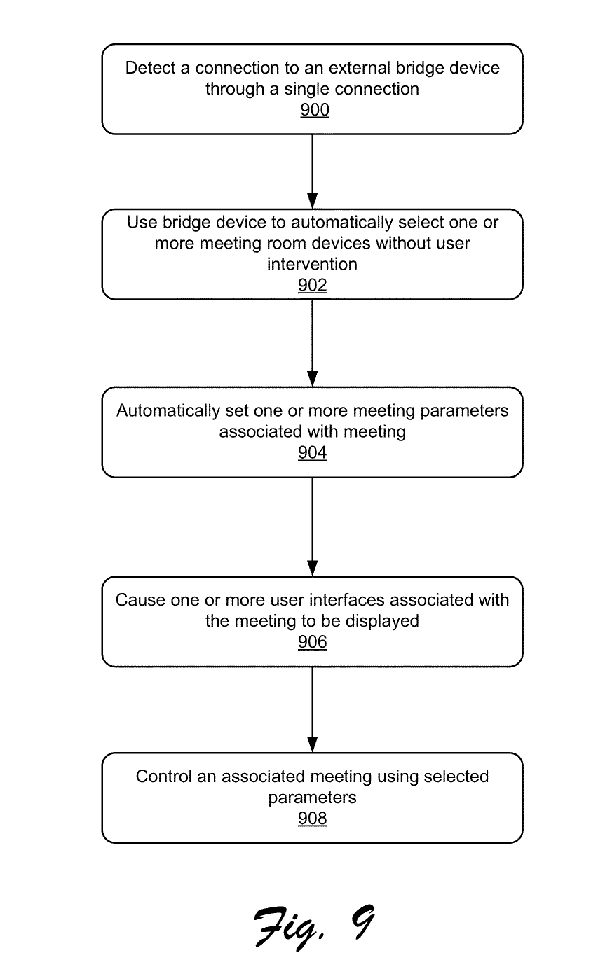

FIG. 9 is a flow diagram that describes steps in a method in accordance with one or more embodiments. The method can be implemented in connection with any suitable hardware, software, firmware, or combination thereof. In at least some embodiments, the method is implemented by a suitably-configured conferencing communication platform in reliance on bridge functionality which may or may not be manifest in the form of a bridge device that is external to a computing device on which the conferencing communication platform executes.

Step 900 detects a connection to an external bridge device through a single connection. Any suitable type of connection can be utilized. In the illustrated and described embodiment, a USB connection is utilized to connect a computing device with the bridge device for purposes of conducting a large meeting. The bridge device, in turn, is connected to one or more meeting room devices, examples of which are provided above. Step 902 uses the bridge device to automatically select one or more meeting room devices without user intervention. In the illustrated and described embodiment, this step can be performed by a suitably-configured conferencing communication platform. The meeting room devices can include, by way of example and not limitation, meeting room speakers, meeting room microphones, meeting room cameras, meeting room projectors, and the like. Step 904 automatically sets one or more meeting parameters associated with the meeting. Any suitable meeting parameters can be automatically set without the need for user intervention. Examples of meeting parameters can include, by way of example and not limitation, the meeting presenter, the meeting attendees, permissions or privileges associated with the meeting attendees, settings associated with the meeting attendees (e.g., microphone mute), and the like. Step 906 causes one or more user interfaces associated with the meeting to be displayed. The user interfaces can be used to provide information to the meeting organizer or presenter, to enable the meeting organizer to run the meeting, and/or to enable the meeting organizer to manipulate various parameters associated with the meeting. This step can be performed by causing the user interfaces to be displayed on the computing device that is connected with the bridge device. Any suitable type of user interfaces can be displayed. For example, FIG. 4 illustrates one user interface which displays information for the meeting organizer including various parameters associated with the meeting, such as those described just above. FIG. 5 illustrates a user interface which enables the meeting to be conducted by the meeting organizer. FIG. 6 illustrates a user interface that enables the meeting organizer to manipulate various parameters associated with the meeting through a permissions tab. FIG. 7 illustrates a user interface that enables the meeting organizer to make various selections associated with audio devices and video devices (by way of the video device tab) associated with the meeting. Step 908 controls an associated meeting using the selected parameters. The selected parameters can include default parameters that were automatically selected by the conferencing communication platform without user intervention. Alternately or additionally, the selected parameters can include user-selected parameters that were selected by way of a suitable user interface, such as those user interfaces described above.

Implementation Details in USB Embodiments

As noted above, in at least some embodiments the bridge device can be implemented using USB technology. Of course, other technology can be used to implement the bridge device without departing from the spirit and scope of the claimed subject matter.

As will be appreciated by the skilled artisan, a USB can support up to 127 different devices or nodes at once since it is actually an addressable bus system, with a seven-bit address code. When a personal computer is connected with its peripherals via the USB, it acts like a Local Area Network (LAN). On the other hand, any device connected to the USB can have a number of other nodes connected to it in daisy-chain fashion. This means the other device can also form a hub for a mini-star sub-network. Similarly, it is possible to have a device which purely functions as a hub for other node devices, with no separate function of its own. This expansion via hubs is possible because the USB supports a tiered star topology. Each USB hub acts as a kind of traffic manager for its part of the network, routing data from the host to its correct address and preventing bus contention clashes between devices trying to send data at the same time. So, in the USB implementation, signals from microphone, camera, speaker and projector are essentially combined into one USB.

When a USB peripheral device is first attached to the network, a process called enumeration process is started. This is the way by which the host communicates with the device to learn its identity and to discover which device driver is required. The enumeration starts by sending a reset signal to the newly connected USB device. The speed of the USB device is determined during the reset signaling. After reset, the host reads the USB device's information, and then the device is assigned a unique 7-bit address. If the device is supported by the host, the device drivers needed for communicating with the device are loaded and the device is set to a configured state. Once a hub detects a new peripheral (or even the removal of one), it actually reports the new information about the peripheral to the host, and enables communications with it. If the USB host is restarted, the enumeration process is repeated for all connected devices.

In other words, the enumeration process is initiated both when the host is powered up and a device connected or removed from the network. This is how, in USB embodiments, the conferencing communication platform is able to learn of the meeting room devices that are connected to the bridge device.

With respect to discoverability and user interface access, when the bridge device is connected to a computing device, the bridge device can be represented as a Large Meeting Device (under the OEM's custom name) in a Control Panel or similar user interface instrumentality, e.g., under the “Devices and Printers” section in the Control Panel. The bridge device will list various device functions that it can implement including, by way of example and not limitation, Audio Input and Output, Human Interface Devices, USB Display Adapter, Imaging Device, and Universal Serial Bus Controller.

Consider now an example device that can be used to implement the embodiments described above.

Example Device

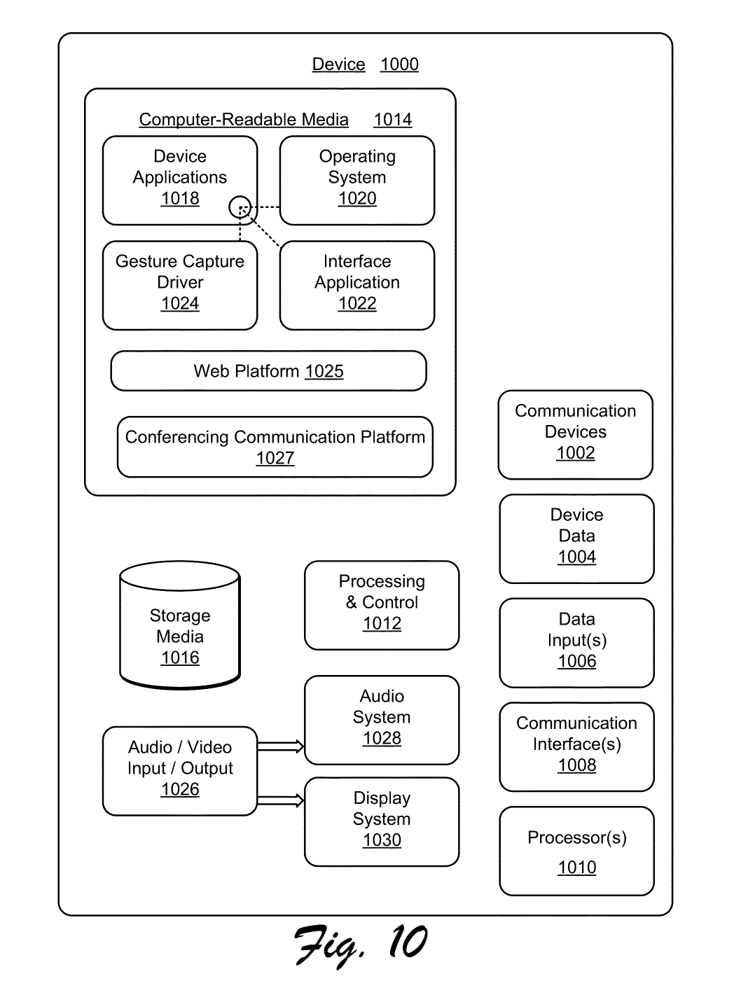

FIG. 10 illustrates various components of an example device 1000 that can be implemented as any type of computing device as described with reference to FIGS. 1 and 3 to implement embodiments of the techniques described herein. Device 1000 includes communication devices 1002 that enable wired and/or wireless communication of device data 1004 (e.g., received data, data that is being received, data scheduled for broadcast, data packets of the data, etc.). The device data 1004 or other device content can include configuration settings of the device, media content stored on the device, and/or information associated with a user of the device. Media content stored on device 1000 can include any type of audio, video, and/or image data. Device 1000 includes one or more data inputs 1006 via which any type of data, media content, and/or inputs can be received, such as user-selectable inputs, messages, music, television media content, recorded video content, and any other type of audio, video, and/or image data received from any content and/or data source.

Device 1000 also includes communication interfaces 1008 that can be implemented as any one or more of a serial and/or parallel interface, a wireless interface, any type of network interface, a modem, and as any other type of communication interface. The communication interfaces 1008 provide a connection and/or communication links between device 1000 and a communication network by which other electronic, computing, and communication devices communicate data with device 1000.

Device 1000 includes one or more processors 1010 (e.g., any of microprocessors, controllers, and the like) which process various computer-executable instructions to control the operation of device 1000 and to implement embodiments of the techniques described herein. Alternatively or in addition, device 1000 can be implemented with any one or combination of hardware, firmware, or fixed logic circuitry that is implemented in connection with processing and control circuits which are generally identified at 1012. Although not shown, device 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1000 also includes computer-readable media 1014, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1000 can also include a mass storage media device 1016.

Computer-readable media 1014 provides data storage mechanisms to store the device data 1004, as well as various device applications 1018 and any other types of information and/or data related to operational aspects of device 1000. For example, an operating system 1020 can be maintained as a computer application with the computer-readable media 1014 and executed on processors 1010. The device applications 1018 can include a device manager (e.g., a control application, software application, signal processing and control module, code that is native to a particular device, a hardware abstraction layer for a particular device, etc.). The device applications 1018 also include any system components or modules to implement embodiments of the techniques described herein. In this example, the device applications 1018 include an interface application 1022 and a gesture capture driver 1024 that are shown as software modules and/or computer applications. The gesture capture driver 1024 is representative of software that is used to provide an interface with a device configured to capture a gesture, such as a touchscreen, track pad, camera, and so on. Alternatively or in addition, the interface application 1022 and the gesture capture driver 1024 can be implemented as hardware, software, firmware, or any combination thereof. Additionally, computer readable media 1014 can include a web platform 1025 and a conferencing communication platform 1027 that functions as described above.

Device 1000 also includes an audio and/or video input-output system 1026 that provides audio data to an audio system 1028 and/or provides video data to a display system 1030. The audio system 1028 and/or the display system 1030 can include any devices that process, display, and/or otherwise render audio, video, and image data. Video signals and audio signals can be communicated from device 1000 to an audio device and/or to a display device via an RF (radio frequency) link, S-video link, composite video link, component video link, DVI (digital video interface), analog audio connection, or other similar communication link. In an embodiment, the audio system 1028 and/or the display system 1030 are implemented as external components to device 1000. Alternatively, the audio system 1028 and/or the display system 1030 are implemented as integrated components of example device 1000.

### Example Implementations

Example implementations utilizing the bridge device described herein include, but are not limited to, one or any combination of one or more of the following example:

A method comprising detecting, by a conferencing communication platform, a large meeting context; responsive to detecting the large meeting context, automatically entering a large meeting mode without user intervention, the large meeting mode enabling one or more of automatic application of policies associated with establishing a large meeting or automatically selecting meeting room devices for use during the large meeting; and controlling an associated large meeting using parameters established in the large meeting mode.

A method as described above, wherein said detecting comprises detecting that a computing device upon which the conferencing communication platform is executing has been physically connected to a bridge device that enables meeting room devices to be utilized by the conferencing communication platform.

A method as described above, wherein said detecting comprises detecting presence of meeting room equipment that is used for conducting meetings, said meeting room equipment comprising equipment that is external to a computing device upon which the conferencing communication platform is executing.

A method as described above, wherein automatic application of policies associated with establishing the large meeting includes one or more of: turning on or off one or more meeting functions, setting permissions for participants, or designating a presenter.

A method as described above, wherein automatically selecting meeting room devices comprises selecting one or more of meeting room speakers, a meeting room microphone, a meeting room projector, or a meeting room camera.

A method as described above, wherein the large meeting mode is configured to enable one or more user interfaces to be presented to enable a meeting organizer to select or modify various meeting parameters.

A method as described above, wherein at least some of the parameters were automatically selected for use when the large meeting mode was entered.

A method as described above, wherein at least some of the parameters are user-selected sufficient to modify automatically selected parameters that were selected when the large meeting mode was entered.

One or more computer readable storage media having instructions stored thereon that, responsive to execution by a computing device, implement a conferencing communication platform configured to perform operations comprising: detecting a connection to an external bridge device through a single connection, the external bridge device being utilized to conduct a large meeting; using the bridge device to automatically select one or more meeting room devices without user intervention; automatically setting one or more meeting parameters associated with the large meeting without user intervention; causing one or more user interfaces associated with the large meeting to be displayed, the one or more user interfaces being configured to enable one or more of the following: provision of information to a meeting organizer, running of the meeting, or manipulation of various parameters associated with the meeting; controlling the large meeting using at least one meeting parameter that was automatically set.

The one or more computer-readable storage media as described above, wherein the single connection comprises a USB connection.

The one or more computer-readable storage media as described above, wherein the meeting room devices comprise one or more of meeting room speakers, meeting room microphones, meeting room cameras, or meeting room projectors.

The one or more computer-readable storage media as described above, wherein the meeting parameters include one or more of: a meeting presenter, meeting attendees, permissions or privileges associated with the meeting attendees, or device settings associated with the meeting attendees.

The one or more computer-readable storage media as described above, wherein the single connection comprises a USB connection.

A system comprising: a bridge device configured to connect multiple devices in a meeting room to a computing device executing a conferencing communication platform that can be used to conduct large meetings, the bridge device comprising: a single data transfer interface configured to connect with the computing device; an audio input configured to connect with a meeting room microphone; a video input configured to connect with a meeting room camera; an audio output configured to connect with meeting room speakers; a video output configured to connect with a meeting room projector.

The system as described above, wherein the single data transfer interface comprises a high-speed media interface.

The system as described above, wherein the single data transfer interface comprises a wireless high-speed interface.

The system as described above, wherein the single data transfer interface comprises a USB interface.

The system as described above, wherein the bridge device is configured to enumerate meeting room devices with which it is connected.

The system as described above further comprising a computing device configured to connect with the bridge device through the single data transfer interface.

The system as described above, further comprising: a computing device configured to connect with the bridge device through the single data transfer interface; and a conferencing communication platform embodied on the computing device and configured to enable large meetings to be conducted.

### CONCLUSION

Various embodiments provide a bridge device that can enable a conferencing communication platform, such as audio/visual conferencing software, to discover that it is in a large meeting context and, automatically enter a so-called “large meeting mode.” In the large meeting mode, the conferencing communication platform can automatically apply policies associated with establishing the meeting and automatically select meeting room equipment for use during the meeting. In addition, the conferencing communication platform can provide a user interface experience to enable a meeting organizer to quickly select and/or modify various meeting parameters.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
detecting, by a conferencing communication platform, a large meeting context;
responsive to detecting the large meeting context, automatically entering a large meeting mode without user intervention, the large meeting mode enabling one or more of automatic application of policies associated with establishing a large meeting or automatically selecting meeting room devices for use during the large meeting; and
controlling an associated large meeting using parameters established in the large meeting mode.

2. The method of claim 1, wherein said detecting comprises detecting that a computing device upon which the conferencing communication platform is executing has been physically connected to a bridge device that enables meeting room devices to be utilized by the conferencing communication platform.

3. The method of claim 1, wherein said detecting comprises detecting presence of meeting room equipment that is used for conducting meetings, said meeting room equipment comprising equipment that is external to a computing device upon which the conferencing communication platform is executing.

4. The method of claim 1, wherein automatic application of policies associated with establishing the large meeting includes one or more of: turning on or off one or more meeting functions, setting permissions for participants, or designating a presenter.

5. The method of claim 1, wherein automatically selecting meeting room devices comprises selecting one or more of meeting room speakers, a meeting room microphone, a meeting room projector, or a meeting room camera.

6. The method of claim 1, wherein the large meeting mode is configured to enable one or more user interfaces to be presented to enable a meeting organizer to select or modify various meeting parameters.

7. The method of claim 1, wherein at least some of the parameters were automatically selected for use when the large meeting mode was entered.

8. The method of claim 1, wherein at least some of the parameters are user-selected sufficient to modify automatically selected parameters that were selected when the large meeting mode was entered.

9. One or more computer readable storage media having instructions stored thereon that, responsive to execution by a computing device, implement a conferencing communication platform configured to perform operations comprising:
detecting a connection to an external bridge device through a single connection, the external bridge device being utilized to conduct a large meeting;
using the bridge device to automatically select one or more meeting room devices without user intervention;
automatically setting one or more meeting parameters associated with the large meeting without user intervention;
causing one or more user interfaces associated with the large meeting to be displayed, the one or more user interfaces being configured to enable one or more of the following:
provision of information to a meeting organizer,
running of the meeting, or
manipulation of various parameters associated with the meeting;
controlling the large meeting using at least one meeting parameter that was automatically set.

10. The one or more computer readable storage media of claim 9, wherein the single connection comprises a USB connection.

11. The one or more computer readable storage media of claim 9, wherein the meeting room devices comprise one or more of meeting room speakers, meeting room microphones, meeting room cameras, or meeting room projectors.

12. The one or more computer readable storage media of claim 9, wherein the meeting parameters include one or more of: a meeting presenter, meeting attendees, permissions or privileges associated with the meeting attendees, or device settings associated with the meeting attendees.

13. The one or more computer readable storage media of claim 9, wherein the single connection comprises a USB connection.

14. A system comprising:
a bridge device configured to connect multiple devices in a meeting room to a computing device executing a conferencing communication platform that can be used to conduct large meetings, the bridge device comprising:
a single data transfer interface configured to connect with the computing device effective to enable a conferencing communication platform executing on the computing device to, once connected to the bridge device and without further user intervention, automatically select one or more meeting room devices for use during a large meeting and automatically set one or more meeting parameters associated with the large meeting;
an audio input configured to connect with a meeting room microphone;
a video input configured to connect with a meeting room camera;
an audio output configured to connect with meeting room speakers; and
a video output configured to connect with a meeting room projector.

15. The system of claim 14, wherein the single data transfer interface comprises a high-speed media interface.

16. The system of claim 14, wherein the single data transfer interface comprises a wireless high-speed interface.

17. The system of claim 14, wherein the single data transfer interface comprises a USB interface.

18. The system of claim 14, wherein the bridge device is configured to enumerate meeting room devices with which it is connected.

19. The system of claim 14 further comprising a computing device configured to connect with the bridge device through the single data transfer interface.

20. The system of claim 14 further comprising:
a computing device configured to connect with the bridge device through the single data transfer interface; and
a conferencing communication platform embodied on the computing device and configured to enable large meetings to be conducted.
